(19) United States
(12) Patent Application Publication
(10) Pub. No.: US 2020/0265408 A1
(43) Pub. Date: Aug. 20, 2020

(54) ANALYTICS-BASED PAYMENT OPTION SELECTION

(71) Applicant: International Business Machines Corporation, Armonk, NY (US)

(72) Inventor: Harish Rajagopal, Sydney (AU)

(21) Appl. No.: 16/279,233

(22) Filed: Feb. 19, 2019

(51) Int. Cl. G06Q 20/22; G06Q 20/32; G06Q 20/14; G06N 5/02; G06F 17/27

(52) U.S. Cl. CPC G06Q 20/227; G06Q 20/3223; G06F 17/2705; G06N 5/02; G06Q 20/14

(57) ABSTRACT

Aspects of the present invention provide an approach for selecting a payment option. Each item of a set of items being purchased during a commercial transaction is extracted from a bill for payment. Additionally, a commercial location at which the commercial transaction is being performed is also determined. For each of a plurality of payment options associated with a purchaser, a set of attributes corresponding to the payment option is generated. Based on these attributes, a cognitive system selects an optimal payment option. This optimal payment option is the one or more of the purchaser's payment options that is determined to generate the greatest benefit for the set of items being purchased at the commercial location.

### TECHNICAL FIELD

The subject matter of the present invention relates generally to payment processing. More specifically, aspects of the present invention provide a solution that uses analytics to select a payment option that is optimized to the particular transaction.

### BACKGROUND

In today's modern world, the number of improvements brought about by new technology is ever increasing. These technological advances have improved previous ways of doing things and have introduced new ways that would have been unimaginable a short time ago. One way that these advances have improved people's lives is by increasing the number of options that a person may have for performing a particular task. However, this increasing number of options may necessitate a greater number of choices that must be made.

One area in which technological advances has increased user options is the area of payment options. Where a few decades ago, most purchasers would have had to select from only cash, check, or a small number of credit or charge cards, by some estimates the mean average number of credit or charge cards held by cardholders in the in the United States today is now 3.7 cards, with over 15% of cardholders owning five or more cards. Moreover, there are now electronic payment options, such as Apple Pay® (Apple Pay is a registered trademark of Apple Computer, Inc.), Samsung Pay® (Samsung Pay is a registered trademark of Samsung, Inc.), and Google Wallet® (Goggle Wallet is a registered trademark of Google, Inc.), among others. Many of these payment options may attempt to distinguish themselves from other options (e.g., to attract more holders) by offering incentives. These incentives may include preferred interest rates on particular items or types of items and/or in particular stores or types of stores, among others.

### SUMMARY

In general, aspects of the present invention provide an approach for selecting a payment option. Each item of a set of items being purchased during a commercial transaction is extracted from a bill for payment. Additionally, a commercial location at which the commercial transaction is being performed is also determined. For each of a plurality of payment options associated with a purchaser, a set of attributes corresponding to the payment option is generated. Based on these attributes, a cognitive system selects an optimal payment option. This optimal payment option is the one or more of the purchaser's payment options that is determined to generate the greatest benefit for the set of items being purchased at the commercial location.

One aspect of the invention provides a computer implemented method for selecting a payment option, comprising: extracting, from a bill for payment, each item of a set of items being purchased during a commercial transaction; determining a commercial location at which the commercial transcation is being performed; generating a set of attributes corresponding to each payment option of a plurality of payment options associated with a purchaser; and selecting, using a cognitive system, an optimal payment option that is determined to generate a greatest benefit for the set of items being purchased at the commercial location based on the set of attributes.

Another aspect of the invention provides a system for selecting a payment option, comprising: a memory medium comprising instructions; a bus coupled to the memory medium; and a processor coupled to the bus that when executing the instructions causes the system to perform a method, comprising: extracting, from a bill for payment, each item of a set of items being purchased during a commercial transaction; determining a commercial location at which the commercial transcation is being performed; generating a set of attributes corresponding to each payment option of a plurality of payment options associated with a purchaser; and selecting, using a cognitive system, an optimal payment option that is determined to generate a greatest benefit for the set of items being purchased at the commercial location based on the set of attributes.

Yet another aspect of the invention provides a computer program product embodied in a computer readable medium that, when executed by a computer device, performs a method for selecting a payment option, the method comprising: extracting, from a bill for payment, each item of a set of items being purchased during a commercial transaction; determining a commercial location at which the commercial transcation is being performed; generating a set of attributes corresponding to each payment option of a plurality of payment options associated with a purchaser; and selecting, using a cognitive system, an optimal payment option that is determined to generate a greatest benefit for the set of items being purchased at the commercial location based on the set of attributes.

Still yet, any of the components of the present invention could be deployed, managed, serviced, etc., by a service provider who offers to implement passive monitoring in a computer system.

Embodiments of the present invention also provide related systems, methods, and/or program products.

### BRIEF DESCRIPTION OF THE DRAWINGS

These and other features of this invention will be more readily understood from the following detailed description of the various aspects of the invention taken in conjunction with the accompanying drawings.

FIG. 1 depicts a data processing system according to an embodiment of the present invention.

FIG. 2 depicts a system diagram according to an embodiment of the present invention.

FIG. 3 depicts an example purchasing environment according to an embodiment of the present invention.

FIGS. 4A-B depict an example data flow diagram according to an embodiment of the present invention.

FIG. 5 depicts an example process flowchart according to an embodiment of the present invention.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION

Illustrative embodiments will now be described more fully herein with reference to the accompanying drawings, in which embodiments are shown. This disclosure may, however, be embodied in many different forms and should not be construed as limited to the embodiments set forth herein. Rather, these embodiments are provided so that this disclosure will be thorough and complete and will fully convey the scope of this disclosure to those skilled in the art. In the description, details of well-known features and techniques may be omitted to avoid unnecessarily obscuring the presented embodiments.

The terminology used herein is for the purpose of describing particular embodiments only and is not intended to be limiting of this disclosure. As used herein, the singular forms “a”, “an”, and “the” are intended to include the plural forms as well, unless the context clearly indicates otherwise. Furthermore, the use of the terms “a”, “an”, etc., do not denote a limitation of quantity, but rather denote the presence of at least one of the referenced items. The term “set” is intended to mean a quantity of at least one. It will be further understood that the terms “comprises” and/or “comprising”, or “includes” and/or “including”, when used in this specification, specify the presence of stated features, regions, integers, steps, operations, elements, and/or components, but do not preclude the presence or addition of one or more other features, regions, integers, steps, operations, elements, components, and/or groups thereof.

As indicated above, aspects of the present invention provide an approach for selecting a payment option. Each item of a set of items being purchased during a commercial transaction is extracted from a bill for payment. Additionally, a commercial location at which the commercial transaction is being performed is also determined. For each of a plurality of payment options associated with a purchaser, a set of attributes corresponding to the payment option is generated. Based on these attributes, a cognitive system selects an optimal payment option. This optimal payment option is the one or more of the purchaser's payment options that is determined to generate the greatest benefit for the set of items being purchased at the commercial location.

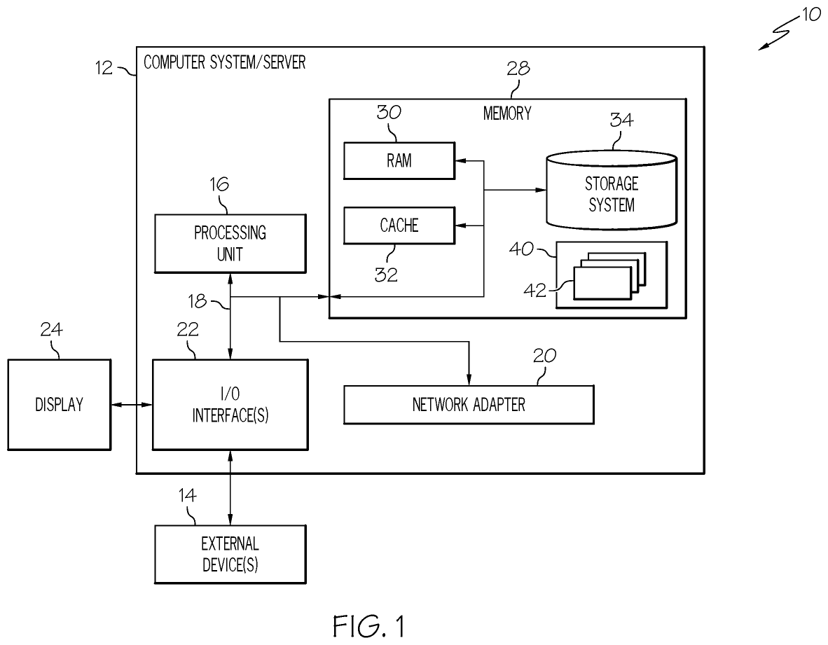

Referring now to FIG. 1, a schematic of an example of a data processing system is shown. Data processing system 10 is only one example of a suitable data processing system and is not intended to suggest any limitation as to the scope of use or functionality of embodiments of the invention described herein. Regardless, data processing system 10 is capable of being implemented and/or performing any of the functionality set forth hereinabove.

In data processing system 10, there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on, that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in data processing system 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and/or an optical disk drive for reading from or writing to a removable, non-volatile optical disk such as a CD-ROM, DVD-ROM, or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program code embodied on a computer readable medium may be transmitted using any appropriate medium including, but not limited to, wireless, wireline, optical fiber cable, radio-frequency (RF), etc., or any suitable combination of the foregoing.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a consumer to interact with computer system/server 12; and/or any devices (e.g., network card, modem, etc.) that enable computer system/server 12 to communicate with one or more other computing devices. Such communication can occur via I/O interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples include, but are not limited to: microcode, device drivers, redundant processing units, external disk drive arrays, RAID systems, tape drives, and data archival storage systems, etc.

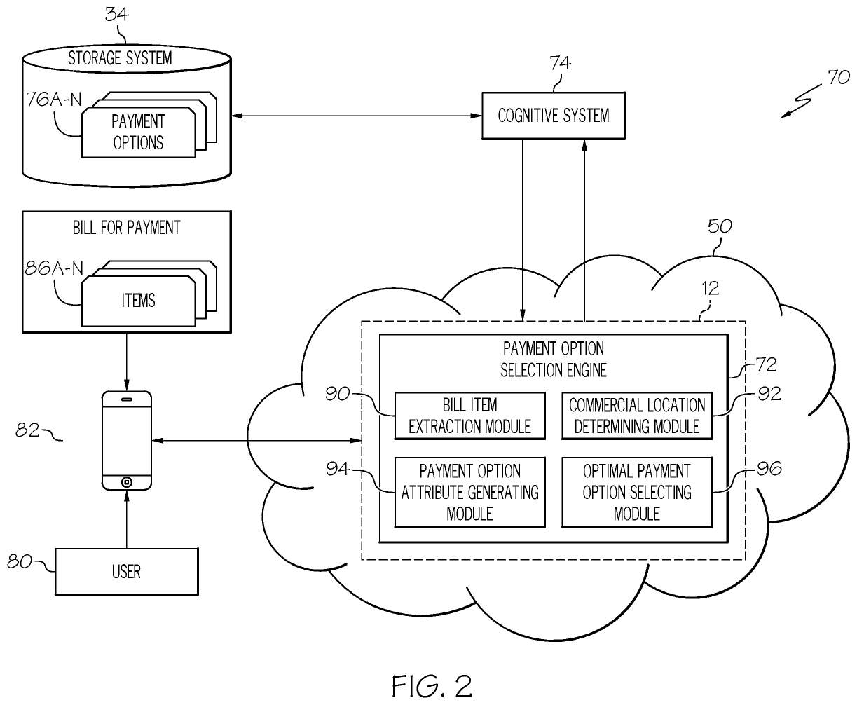

Referring now to FIG. 2, a system diagram describing the functionality discussed herein according to an embodiment of the present invention is shown. It is understood that the teachings recited herein may be practiced within any type of networked computing environment 70 (e.g., a cloud computing environment 50). A stand-alone computer system/server 12 is shown in FIG. 2 for illustrative purposes only. In the event the teachings recited herein are practiced in a networked computing environment 70, a payment option selection engine (hereinafter “system 72”) may be executing (e.g., as an application running thereon) on each mobile device 82. Alternatively, all or a portion of system 72 could be loaded on a server or server-capable device that communicates (e.g., wirelessly) with mobile device 82 to provide processing therefor. Regardless, as depicted, system 72 is shown within computer system/server 12. In general, system 72 can be implemented as program/utility 40 on computer system/server 12 of FIG. 1 and can enable the functions recited herein. It is further understood that system 72 may be incorporated within or work in conjunction with any type of system that receives, processes, and/or executes commands to enable an optimum selection of a payment option 76N for a specific group of items 86A-N being purchased at a particular commercial location. Such other system(s) have not been shown in FIG. 2 for brevity purposes.

Along these lines, system 72 may perform multiple functions similar to a general-purpose computer. Specifically, among other functions, system 72 can select an optimum payment option 76N (e.g., from among a plurality of available payment options 76A-N). To accomplish this, system 72 can include: a bill item extraction module 90, a commercial location determining module 92, a payment option attribute generating module 94, and an optimal payment option selecting module 96.

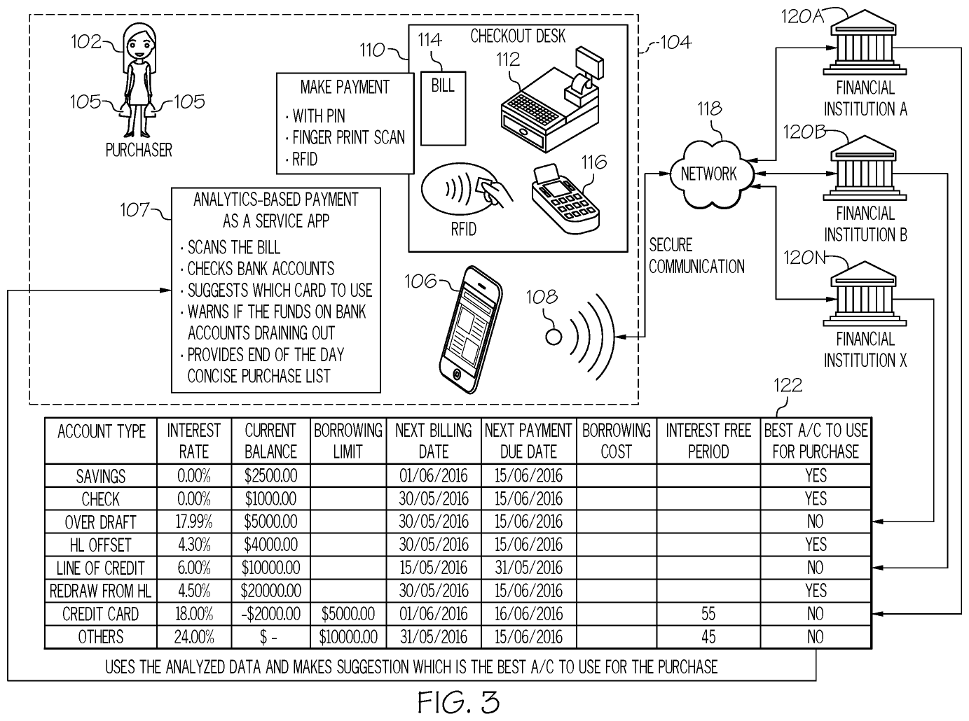

Referring now to FIG. 3, an example purchasing environment 100 is shown according to an embodiment of the invention. As shown, a human shopper (hereinafter referred to as “purchaser”) 102 is shopping in commercial location 104. Commercial location 104 can be any location in which purchaser 102 can go to purchase one or more items 105, including, but not limited to: a grocery store, a gasoline station, a restaurant, an airport/travel terminal, a department store, a hardware/home improvement store, a boutique store, a clothing store, a warehouse store, a pharmacy, and/or the like. In any case, purchaser 102 selects the goods or services that purchaser 102 wishes to purchase from commercial location 104 and proceeds to a checkout desk 110 in order to pay for the items 105. In an example, checkout desk 110 can include a point of sale device 112, such as a cash register, that can be used to produce a bill for payment 114. Bill for payment 114 can be outputted in a tangile format (e.g., paper) and/or can be maintained in electronic format on point of sale device 112. In any case, checkout desk 110 can also include one or more payment processing units 116, which can be used to process one or more different forms of payment provided by purchaser 102. These forms of payment can include, but are not limited to: charge cards, credit cards, debit cards, electronic payment options, and/or the like. In any case, payment processing unit 116 can be integrated into point of sale device 112 or can be separate from, but in some cases in communication with, point of sale device 112. Further, an option can be provided to split payment for different types of items being presented by purchaser 104 for purchase in a single transaction into a plurality of individual sub-transactions that are grouped by common method of payment. In any case, at checkout desk 110, purchaser 102 can select a payment option 76N and can present (e.g., by swiping, tapping, and/or the like) the selected payment option 76N at payment processing unit 116. Payment processing unit 116 can then forward the information received from payment option 76N to an appropriate financial institution for payment 120N.

The inventors of the invention described herein have discovered certain deficiencies in the current solutions for selecting a payment option 76N to be used for a particular commercial transaction. For example, in the world of today, in which a purchaser 102 may have multiple different payment options 76A-N to select from, the purchaser 102 will often fail to select the optimal payment option 76N for the situation. For example, many purchasers 102 do not know the attributes (e.g., regular, store, and item-related interest rates; regular, store-related, and item-related bonus points; regular, item-related, and store-related rebates; purchase insurance availability; etc.) for each available payment option. For this reason, purchasers 102 may tend to either have a single preferred payment option 76N that they use in almost all transactions or may tend to select payment options 76A-N at random. Moreover, even if a purchaser 102 does know some attributes of a payment option 76N, the purchaser 102 may not realize that the attributes have changed, such as due to a policy change, the user approaching a purchasing threshold, etc. These may be a particular concern when shopping occurs out of the country, where different exchange rates and/or spending limits may apply.

The approach set forth herein overcomes some or all of these deficiencies in current solutions. To accomplish this, a mobile device 106 belonging to purchaser 102 can be used to either execute or access an analytics-based payment as a service (APaaS) application 107. In the embodiments described herein, APaaS application 107 includes a user interface that communicates (through audio tones, images, and/or physical movement, such as a virbation generated by mobile device 106) payment options to a user of mobile device 106. This APaaS application 107 interacts with consumer's bank accounts on the fly and suggests which payment option (e.g., card or cards) to use for each individual transaction.

In an embodiment, APaaS application 107 can include a set of user preferences (e.g., a preference for a longer time to make a payment over an interest rate that is lower than less than a predefined number of percentage points) that purchaser 102 can specify and that can be used in cases in which one benefit may not be clearly superior to another. This allows purchaser 102 to always select the payment option 76N that provides purchaser 102 the greatest benefit for the transaction at checkout desk 110. Moreover, in some embodiments, the selected payment option 76N can be automatically submitted by mobile device 106 to payment processing unit 116.

In yet another embodiment, APaaS application 107 can provide the option of splitting the payment for different types of items purchased/included in a single transaction. In doing so APaaS could generate multiple sub-transactions, with each sub-transaction being being for a subset of the total amount of items that are being payed for with a different payment option 74N that is determined to provide the optimum benefit to consumer 104. Each of these sub-transactions could then be submitted, with its determined payment option 76A-N, at checkout desk 110. For example, if purchaser 104 goes to a gas station and buys gas, snacks, and a magazine, and APaaS application 107 determines that each type of purchased item is benefited by one particular card/payment option 76A-N, the system presents the options to split the bill and pay for each using those methods. Purchaser 104 could still see the total spent on a single “receipt” generated by APaaS application 107. APaaS could also provide the option for purchaser 104 to expand the “receipt” so that the details of the sub-transactions are also visible.

To this extent, any purchaser 102 with a mobile device 106 (e.g., smart phone, tablet, personal data assistant, etc.) can leverage APaaS application 107 to pay the bills and be in control of spending. This reduces or eliminates the need to log into individual bank/credit cards, or other payment accounts. Moreover, purchaser 102 can be provided with ongoing and/or end of day summaries, allowing purchaser 102 to more easily track spending both during and after a shopping trip.

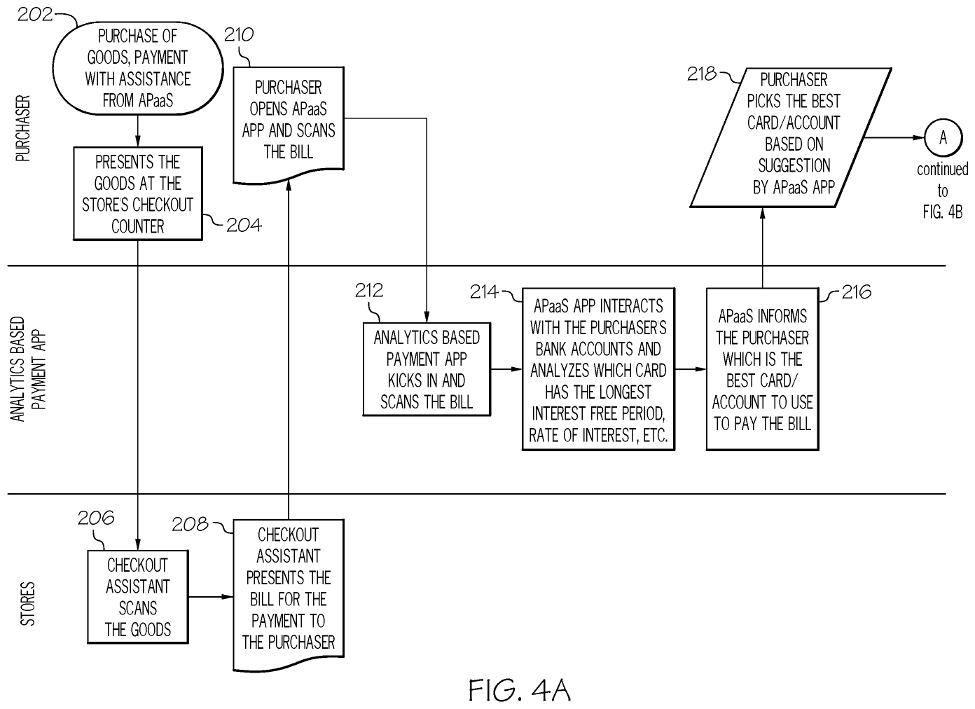

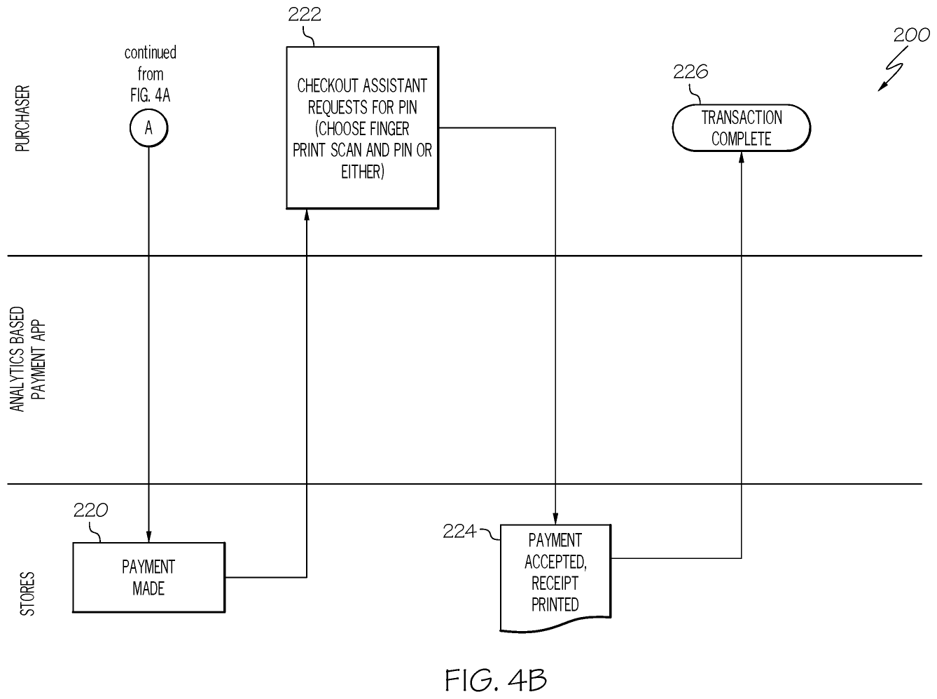

Referring now to FIGS. 4A-B, an example data flow diagram 200 is depicted according to an embodiment of the current invention. Referring additionally to FIG. 3, when, at 202, purchaser 102 wishes to conduct a purchase of goods/services with payment being made with assistance from APaaS application 107, purchaser 102 selects the desired goods/services and presents the goods/services at the commercial location's 104 checkout desk 110 at 204. At 206, the goods/services being purchased are entered into point of sale device 112 (e.g., scanned by a checkout assistant, self scanned by purchaser 102, automatically transferred from a remote scanning device, etc.). In any case, once goods/services have been entered, at 208, a bill for payment 114 can be presented for payment to purchaser 102. Bill for payment 114 can be in a physical format (e.g., paper) which is handed to purchaser 102 (e.g., by the checkout assistant) or printed out by point of sale device 112 for retrieval by purchaser 102. Alternatively, bill for payment 114 can be in an electronic form that is transferred electronically to mobile device 106.

Referring additionally to FIG. 2 again, bill item extraction module 90 of system 72, as executed by computer system/server 12, is configured to extract, from a bill for payment 84, each item 86N of a set of items 86A-N being purchased during a commercial transaction. To accomplish this, at 210, purchaser 102 can open APaaS application 107 and scan the bill for payment 114, and APaaS application 107 can scan through the information in the bill for payment 114. In cases in which bill for payment 114 is provided in a physical format, purchaser 102 can use features of mobile device 106 to upload the information from bill for payment 114. For example, a camera or other imaging technology on mobile device 106 can be used to photograph bill for payment 114. Alternatively, at 212, a scanner that is coupled to mobile device 106 and/or available at checkout desk 110 can be used to scan bill for payment 114 into mobile device 106. In either case, the photographic or scanned images of bill for payment 114 can be converted to text for processing. In alternative embodiments in which bill for payment 114 is in an electronic format, the information in bill for payment 114 can be processed directly.

Whatever the case, this processing can involve parsing each line item, including any text, price, SKU or other alphanumerical identification code, etc., to identify each item being purchased. The parsed information can be forwarded to cognitive system 74, which can determine associated characteristics of each item being purchased. In an embodiment, cognitive system 74 can compare the parsed information to information stored in one or more databases (e.g., storage system 34) accessable to cognitive system 74. Alternatively, cognitive system 74 can use this parsed information to search publically available data from product websites, websites of other sellers, social media sites, and/or the like. In any case, the characteristics determined by cognitive system 74 can include, but are not limited to: make of the item, model of the item, a classification (e.g., gasoline, grocery, pharmaceutical, clothing, jewelry, hardware, appliance, homeware, airline ticket, automobile rental, etc.) of the item, etc.

Commercial location determining module 92 of system 72, as executed by computer system/server 12, is configured to determine a commercial location 104 at which the commercial transaction is being performed. This can be accomplished in a number of different ways. For example, commercial location 104 can be extracted from bill for payment 84 by cognitive system 74 (e.g., using the above-described techniques for extracting the items). Additionally or in the alternative, mobile device 106 can use location technology (e.g., global positioning, wireless triangulation, and/or the like) to determine a physical location for purchaser 102 and can communicate 108 the physical location to cognitive system 74. Cognitive system 74 can use the information to determine which commercial location 104 corresponds to the physical location. In any event, cognitive system 74 can also generate commercial location characteristics for the commercial location. These commercial location characteristics can include a classification of the commercial location 104 (e.g., grocery store, gasoline station, airport, department store, boutique store, clothing store, pharmacy, etc.). Further, in cases in which purchaser 102 is traveling out of the country, commercial location characteristics can also include a country in which the commercial location 104 is located.

Payment option attribute generating module 94 of system 72, as executed on computer system/server 12, is configured to generate a set of attributes corresponding to each of a plurality of payment options associated with purchaser 102. To accomplish this, payment option attribute generating module 94 can access a list of available payment options 76A-N that are associated with purchaser 102. These payment options 76A-N can include any or all charge cards, credit cards, debit cards, electronic payment options available to the purchaser, and/or the like. In an embodiment, payment options 76A-N, along with information for accessing the financial institutions 120A-N, may have been previously entered by purchaser 102 into mobile device 82 and/or an offsite location. This information can be used at 214 by payment option attribute generating module 94 to contact 108 financial institutions 120A-N over network 118 and retrieve source of funds 122 information from financial institutions 120A-N. This source of funds 122 information can be used to generate the set of attributes for each payment option 76N of payment options 76A-N. The attributes for each payment option 76N may include, but are not limited to: an interest rate, any item-related discount interest rate, any location-related discount interest rate, any length of time during which the interest rate is free, any purchase insurance availability, a foreign exchange rate, available credit, any rewards points, any item-related bonus rewards points, any location-related rewards points, any rebates, any item-related bonus rebates, any location-related bonus rebates, and/or the like.

Optimal payment option selecting module 96 of system 72, as executed on computer system/server 12, is configured to select an optimal payment option 76A for the set of items being purchased at the commercial location. To accomplish this, cognitive system 74 can analyze set of items 86A-N to find one or more payment options 76A-N that generate the greatest benefit to purchaser 102 for the specific set of items 86A-N purchased at the specific commercial location 104. For example, if an item being purchased by purchaser 102 is airline tickets, payment option 76N selected by cognitive system 74 may include a charge card that gives double airline miles and one free checked bag for airline purchased. Similarly, if an item being purchased is car rental, payment option 76N selected by cognitive system 74 may include a credit card that has rental insurance. In another example, if commercial location 104 is a grocery store, payment option 76N selected by cognitive system 74 may include an electronic payment option that has a preferential interest rate for items purchased in a grocery store.

In yet another example, if purchaser 102 is purchasing one or more items in a country with a different currency, cognitive system 74 may select payment option 76M that has a favorable exchange rate or no foreign transaction fee over another payment option 76N that has an unfavorable interst rate or foreign transaction fee, even though other attributes (e.g., the interest rate) for the other payment option 76N may be better. Alternativaly, if cognitive system 74 determines that the exchange rate to withdraw cash is better than that of using other payment options 76A-N (e.g., credit cards), payment option 76N selected by cognitive system 74 may be a debit card and cognitive system 74 may direct purchaser 102 to the nearest automatic teller machines (ATMs) where the user may withdraw cash to pay for the transaction. In another example, APaaS application 107 may leverage cognitive system 74 to predict the future exchange rates by maintaining local database and constantly updating the exchange rates and may advise the user of the best time and location to exchange currencies on a future trip.

In an embodiment, optimal payment option selecting module 96 can suggest multiple payment options 76A-N if one payment option is optimal for one set of items in bill for payment 114 while another payment option is optimal for another set of items in bill for payment 114. To accomplish this, the second set of items is extracted and their attributes determined. Then cognitive system 74 selects a second optimal payment option that is determined to generate a greatest benefit to purchaser 102 for the second set of items being purchased at the commercial location based on the set of attributes. For example, assume purchaser 102 decides to purchase both gasoline and groceries at a convenience store. Cognitive system 74 may select a payment option 76M that provides a $0.10 per gallon discount for the gasoline and a second payment option 76N that gives preferable rewards points for the groceries.

In any case, at 216, APaaS application 107 can inform purchaser 102 which is the best payment option 76N or options 76A-N to use to pay for the items. Alternatively, APaaS application 107 can provide a ranked selection of payment options 76A-N to purchaser 102, along with a list of applicable benefits for each. Then, at 218, purchaser 102 can select a payment option 76N based on the recommendation, and the payment can be made at 220. Alternatively, APaaS application 107 can automatically select and make the payment if directed to by purchaser 102. In any case, purchaser 102 can be prompted for a PIN or other authentication verification solution at 222. Based on this information, at 224, the payment is accepted and the transaction is completed at 226.

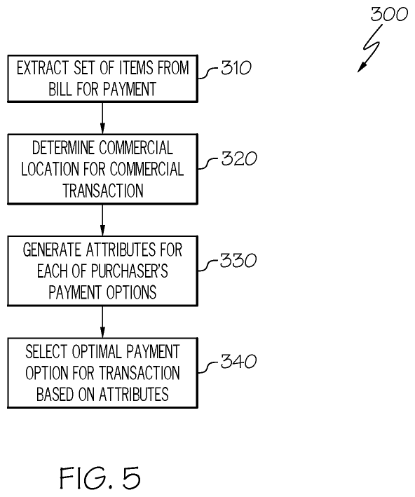

Referring now to FIG. 5 in conjunction with FIG. 2, a process flowchart 300 according to an embodiment of the present invention is shown. At 310, bill item extraction module 90 of system 72, as executed by computer system/server 12, extracts a set of items 86A-N from bill for payment 84. At 320, commercial location determining module 92, as executed by computer system/server 12, determines commercial location 104 (FIG. 3) for the commercial transaction. At 330, payment option attribute generating module 94, as executed by computer system/server 12, generates attributes for each of user's 80 payment options 76A-N. Finally, at 340, optimal payment option selection module, as executed by computer system/server 12, selects an optimal payment option 76N for the transaction based on the attributes.

The process flowchart of FIG. 5 illustrates the architecture, functionality, and operation of possible implementations of systems, methods, and computer program products according to various embodiments of the present invention. In this regard, each block in the flowchart may represent a module, segment, or portion of code, which comprises one or more executable instructions for implementing the specified logical function(s). It should also be noted that, in some alternative implementations, the functions noted in the blocks might occur out of the order depicted in the Figures. For example, two blocks shown in succession may, in fact, be executed substantially concurrently. It will also be noted that each block of flowchart illustration can be implemented by special purpose hardware-based systems that perform the specified functions or acts, or combinations of special purpose hardware and computer instructions.

While shown and described herein as an approach for selecting a payment option, it is understood that the invention further provides various alternative embodiments. For example, in one embodiment, the invention provides a method that performs the process of the invention on a subscription, advertising, and/or fee basis. That is, a service provider, such as a Solution Integrator, could offer to provide functionality for selecting a payment option. In this case, the service provider can create, maintain, support, etc., a computer infrastructure, such as computer system 12 (FIG. 1) that performs the processes of the invention for one or more consumers. In return, the service provider can receive payment from the consumer(s) under a subscription and/or fee agreement and/or the service provider can receive payment from the sale of advertising content to one or more third parties.

In another embodiment, the invention provides a computer-implemented method for selecting a payment option. In this case, a computer infrastructure, such as computer system 12 (FIG. 1), can be provided and one or more systems for performing the processes of the invention can be obtained (e.g., created, purchased, used, modified, etc.) and deployed to the computer infrastructure. To this extent, the deployment of a system can comprise one or more of: (1) installing program code on a computing device, such as computer system 12 (FIG. 1), from a computer-readable medium; (2) adding one or more computing devices to the computer infrastructure; and (3) incorporating and/or modifying one or more existing systems of the computer infrastructure to enable the computer infrastructure to perform the processes of the invention.

Some of the functional components described in this specification have been labeled as systems or units in order to more particularly emphasize their implementation independence. For example, a system or unit may be implemented as a hardware circuit comprising custom VLSI circuits or gate arrays, off-the-shelf semiconductors such as logic chips, transistors, or other discrete components. A system or unit may also be implemented in programmable hardware devices such as field programmable gate arrays, programmable array logic, programmable logic devices or the like. A system or unit may also be implemented in software for execution by various types of processors. A system or unit or component of executable code may, for instance, comprise one or more physical or logical blocks of computer instructions, which may, for instance, be organized as an object, procedure, or function. Nevertheless, the executables of an identified system or unit need not be physically located together, but may comprise disparate instructions stored in different locations which, when joined logically together, comprise the system or unit and achieve the stated purpose for the system or unit.

Further, a system or unit of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices and disparate memory devices.

Furthermore, systems/units may also be implemented as a combination of software and one or more hardware devices. For instance, system 72 may be embodied in the combination of a software executable code stored on a memory medium (e.g., memory storage device). In a further example, a system or unit may be the combination of a processor that operates on a set of operational data.

As noted above, some of the embodiments may be embodied in hardware. The hardware may be referenced as a hardware element. In general, a hardware element may refer to any hardware structures arranged to perform certain operations. In one embodiment, for example, the hardware elements may include any analog or digital electrical or electronic elements fabricated on a substrate. The fabrication may be performed using silicon-based integrated circuit (IC) techniques, such as complementary metal oxide semiconductor (CMOS), bipolar, and bipolar CMOS (BiCMOS) techniques, for example. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor devices, chips, microchips, chip sets, and so forth. However, the embodiments are not limited in this context.

Also noted above, some embodiments may be embodied in software. The software may be referenced as a software element. In general, a software element may refer to any software structures arranged to perform certain operations. In one embodiment, for example, the software elements may include program instructions and/or data adapted for execution by a hardware element, such as a processor. Program instructions may include an organized list of commands comprising words, values, or symbols arranged in a predetermined syntax that, when executed, may cause a processor to perform a corresponding set of operations.

The present invention may also be a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media/(e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

It is apparent that there has been provided approaches for selecting a payment option. While the invention has been particularly shown and described in conjunction with exemplary embodiments, it will be appreciated that variations and modifications will occur to those skilled in the art. Therefore, it is to be understood that the appended claims are intended to cover all such modifications and changes that fall within the true spirit of the invention.

1. A computer implemented method for selecting a payment option, comprising:
extracting, by a mobile device of a user from a bill for payment, each item of a set of items being purchased during a commercial transaction;
determining, by the mobile device, a commercial location at which the commercial transaction is being performed;
generating a set of attributes corresponding to each payment option of a plurality of payment options associated with a purchaser;
identifying, by a cognitive system that is separate from the mobile device, a benefit from using the payment option for every item of the set of items at the commercial location based on the set of attributes for each payment option of the plurality of payment options;
automatically selecting, using the cognitive system, a set of optimal payment options that includes an optimal payment option that is determined to generate a greatest economic benefit for every item of the set of items being purchased at the commercial location based on the set of attributes; and
automatically submitting, by the mobile device, the optimal payment option selected by the cognitive system as the payment option for the set of items.

2. The method of claim 1, further comprising:
uploading the bill for payment to the mobile device,
wherein the extracting further comprises, for each line item in the bill for payment:
parsing the line item:
determining the item being purchased in the line item; and
determining an item type for the item being purchased.

3. The method of claim 2, wherein the uploading is performed by electronically transferring the bill for payment from a point of sale payment system.

4. The method of claim 2, wherein the commercial location is selected from a group consisting of: grocery store, gasoline station, restaurant, airport, department store, home improvement store, boutique store, clothing store, warehouse store, and pharmacy.

5. The method of claim 1, wherein the payment options include a plurality of charge cards, credit cards, debit cards, and electronic payment options available to the purchaser.

6. The method of claim 5, wherein the set of attributes includes an interest rate, any item-related discount interest rate, any location-related discount interest rate, any foreign exchange rate, any purchase insurance availability, any rewards points, any item related bonus rewards points, any location-related rewards points, any rebates, any item-related bonus rebates, and any location-related bonus rebates.

7. The method of claim 1, further comprising:
extracting a second set of items from the bill for payment; and
selecting, using the cognitive system, a second optimal payment option that is determined to generate a greatest economic benefit for the second set of items being purchased at the commercial location based on the set of attributes.

8. A system for selecting a payment option, comprising:
a memory medium comprising instructions;
a bus coupled to the memory medium; and
a processor coupled to the bus that when executing the instructions causes the system to perform a method, comprising:
extracting, by a mobile device of a user from a bill for payment, each item of a set of items being purchased during a commercial transaction;
determining, by the mobile device, a commercial location at which the commercial transaction is being performed;
generating a set of attributes corresponding to each payment option of a plurality of payment options associated with a purchaser;
identifying, by a cognitive system that is separate from the mobile device, a benefit from using the payment option for every item of the set of items at the commercial location based on the set of attributes for each payment option of the plurality of payment options;
automatically selecting, using the cognitive system, a set of optimal payment options that includes an optimal payment option that is determined to generate a greatest economic benefit for every item of the set of items being purchased at the commercial location based on the set of attributes; and
automatically submitting, by the mobile device, the optimal payment option selected by the cognitive system as the payment option for the set of items.

9. The system of claim 8, the method further comprising:
uploading the bill for payment to the mobile device,
wherein the extracting further comprises, for each line item in the bill for payment:
parsing the line item:
determining the item being purchased in the line item; and
determining an item type for the item being purchased.

10. The system of claim 9, wherein the uploading is performed by electronically transferring the bill for payment from a point of sale payment system.

11. The system of claim 9, wherein the commercial location is selected from a group consisting of: grocery store, gasoline station, restaurant, airport, department store, home improvement store, boutique store, clothing store, warehouse store, and pharmacy.

12. The system of claim 8, wherein the payment options include a plurality of charge cards, credit cards, debit cards, and electronic payment options available to the purchaser.

13. The system of claim 12, wherein the set of attributes includes an interest rate, any item-related discount interest rate, any location-related discount interest rate, any foreign exchange rate, any purchase insurance availability, any rewards points, any item-related bonus rewards points, any location-related rewards points, any rebates, any item-related bonus rebates, and any location-related bonus rebates.

14. The system of claim 8, the method further comprising:
extracting a second set of items from the bill for payment; and
selecting, using the cognitive system, a second optimal payment option that is determined to generate a greatest economic benefit for the second set of items being purchased at the commercial location based on the set of attributes.

15. A computer program product embodied in a computer readable medium that, when executed by a computer device, performs a method for selecting a payment option, the method comprising:
extracting, by a mobile device of a user from a bill for payment, each item of a set of items being purchased during a commercial transaction;
determining, by the mobile device, a commercial location at which the commercial transaction is being performed;
generating a set of attributes corresponding to each payment option of a plurality of payment options associated with a purchaser;
identifying, by a cognitive system that is separate from the mobile device, a benefit from using the payment option for every item of the set of items at the commercial location based on the set of attributes for each payment option of the plurality of payment options;
automatically selecting, using the cognitive system, a set of optimal payment options that includes an optimal payment option that is determined to generate a greatest economic benefit for every item of the set of items being purchased at the commercial location based on the set of attributes; and
automatically submitting, by the mobile device, the optimal payment option selected by the cognitive system as the payment option for the set of items.

16. The program product of claim 15, the method further comprising:
uploading the bill for payment to the mobile device,
wherein the extracting further comprises, for each line item in the bill for payment:
parsing the line item:
determining the item being purchased in the line item; and
determining an item type for the item being purchased.

17. The program product of claim 16, wherein the uploading is performed by electronically transferring the bill for payment from a point of sale payment system.

18. The program product of claim 15,
wherein the commercial location is selected from a group, consisting of: grocery store, gasoline station, restaurant, airport, department store, home improvement store, boutique store, clothing store, warehouse store, and pharmacy, and
wherein the payment options include a plurality of charge cards, credit cards, debit cards, and electronic payment options available to the purchaser.

19. The program product of claim 18, wherein the set of attributes includes an interest rate, any item-related discount interest rate, any location-related discount interest rate, any foreign exchange rate, any purchase insurance availability, any rewards points, any item-related bonus rewards points, any location-related rewards points, any rebates, any item-related bonus rebates, and any location-related bonus rebates.

20. The program product of claim 15, the method further comprising:
extracting a second set of items from the bill for payment; and
selecting, using the cognitive system, a second optimal payment option that is determined to generate a greatest economic benefit for the second set of items being purchased at the commercial location based on the set of attributes.
